(19) United States
(12) Patent Application Publication
(10) Pub. No.: US 2004/0259070 A1
(43) Pub. Date: Dec. 23, 2004

(54) Child/infant play and entertainment devices including electronic displays

(76) Inventor: Shelley R. Goodstein, Tucson, AZ (US)

Correspondence Address: WEISS & MOY PC, 4204 NORTH BROWN AVENUE, SCOTTSDALE, AZ, 85251, US

(21) Appl. No.: 10/600,488

(22) Filed: Jun. 20, 2003

(51) Int. Cl. G09B 25/00; A63H 33/00

(52) U.S. Cl. 434/428; 434/365

(57) ABSTRACT

Child/infant play and entertainment devices including electronic displays provide applications of display technology to the child/infant toy and entertainment industry. Flexible displays are used in infant items that require safety measures such as no sharp corners, hard structures or breakable parts. Battery powered devices provide portability and convenience and remote programming connections are be employed to provide wired or wireless reprogramming of the appearance and/or behavior of a child/infant play or entertainment device. Sound features may also be incorporated in synchrony with the visual display for further enhancing the play or entertainment experience.

### BACKGROUND OF THE INVENTION

1. Field of the Invention

The present invention relates generally to child/infant play and entertainment items and more specifically to child and infant play and entertainment devices including one or more electronic displays.

2. Background of the Invention

Technological innovation associated with electronics and electronic displays has proceeded more slowly in baby and child play and entertainment devices than in other product areas. In part, the slower progress has been due to the additional cost of the electronics and electronic displays, but safety considerations have also been a factor. Electronic displays (such as liquid crystal displays (LCDs) typically require a hard case for protection, and include glass and plastic elements that can be dangerous to a child or infant when shattered. Therefore, due to cost and safety considerations, toys which emulate display-based electronic equipment do not include actual displays, but rather include depictions of displays in locations where those displays would normally be included.

In the recent past, electronic display technology has improved to yield increasingly low-cost, low power and flexible graphical and textual displays, such as organic light-emitting diode (OLED) displays. Typically developed for use in electronic books and electronic paper applications, the structure and flexibility of such displays provides an alternative to a hard-cased and rigid LCD display. Also, for some applications, the falling cost of both rigid and flexible displays make them increasingly desirable in applications for infants and children.

Therefore, it would be desirable to provide child/infant play and entertainment devices that incorporate flexible displays to provide safety and novel applications for displays in child/infant play and entertainment devices. It would further be desirable to provide child/infant play and entertainment devices that incorporate rigid or flexible displays to novel applications where flexibility is not a requirement.

### SUMMARY OF THE INVENTION

The above objectives of providing child/infant play and entertainment devices are accomplished in a variety of devices that incorporate electronic displays. Flexible displays are incorporated in baby toys and other infant devices where safety and/or structure dictates that no hard surfaces, sharp corners and/or breakable parts are present. Flexible or rigid displays are incorporated in other child entertainment devices that do not require the use of flexible displays for safety. The devices may be battery operated when desirable for portability or convenience and a wireless or wired interface to a remote programming device such as an Internet-connected computer may be provided for changing the appearance and features of a device. Sound features may also be incorporated in synchrony with the visual display for further enhancing the play or entertainment experience.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIGS. 1 to 18 are pictorial diagrams depicting infant/child play and entertainment devices in accordance with embodiments of the present invention.

FIG. 19 is a block diagram depicting an electronic system for operating the displays incorporated within the devices of FIGS. 1 to 18 in accordance with embodiments of the present invention.

### DETAILED DESCRIPTION OF THE PREFERRED EMBODIMENTS

The present invention provides various interactive and display improvements to children's and infant's play and entertainment devices. The improvements include multipixel graphic displays integrated within a toy or other device body as depicted in the figures. The multipixel graphic displays are indicated in the drawings by the reference numeral 10A-X which differ by shape and size and may include multiple displays as indicated, but will generally be organic light-emitting diode (OLED) displays in applications for infants, where flexibility and lack of breakable parts is required or desirable. The graphic displays are used to display static images, including photographs, which may be digital or digitized photographs of familiar images (e.g., the child/infant or parent's face). The graphic displays may also be used to display animated figures, or static or animated colors or patterns.

In other applications where flexibility is not required, an OLED may be employed or another display type such as a liquid crystal display (LCD) may alternatively be used. Sound, supplied by a transducer incorporated within the toy or other device body can be synchronized with the programming of the display to further enhance the entertainment or play experience. The electronics for driving and programming the display can be located within the device, where permitted, as can a battery power supply. Alternatively, for applications where the device does not have to be self-contained, the electronics may be located remotely and the power supply may alternatively be a wall power supply or other suitable power source.

FIGS. 1-18, along with the descriptions of the figures supplied below, provide illustrative embodiments of the present invention that should be considered exemplary, but not limiting of the present invention.

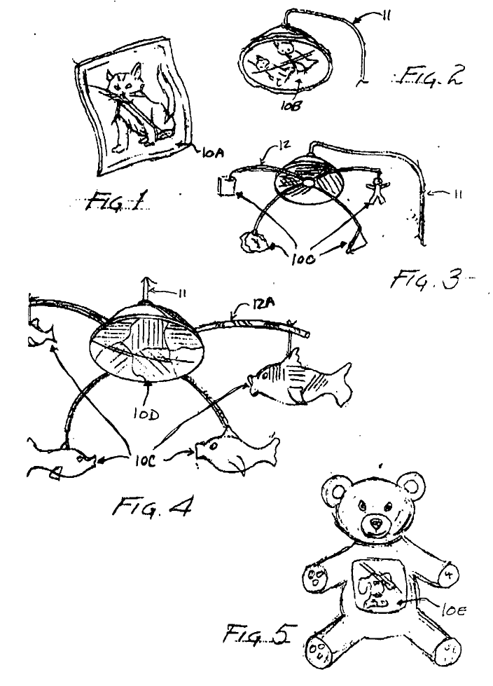

Referring now to FIG. 1, such a display-incorporating device is depicted, comprising a thin flexible sheet incorporating a display 10A for use on a floor as a play mat, or which may be hung on a wall, car seat, crib, changing table, play pen, high chair, car seat or other location for providing attractive displays to infants. FIGS. 2-4 depict embodiments of a mobile or other device for suspension above an infant in a crib. FIG. 2 is a display suspended by an arm 11 for locating a display over a crib. The display may be a curved (convex or concave surface) or may be flat. FIG. 3 is a mobile incorporating displays 10C hanging from suspension arms 12 and cut in various shapes. The shapes can change patterns or colors by virtue of programming displays 10C with varying patterns and colors. FIG. 4 is another mobile incorporating shape-cut displays 10C and further incorporating a center display 10D similar to the display of FIG. 2. While the “shape-cut” displays are produced with cut figures for the display packaging (generally a plastic laminate enclosing OLED elements), the circuit patterns interconnecting the display elements are designed so as to avoid the cutting lines. Suspension arms 12A may also be made with wrap-around display material, so that the entire structure of the mobile of FIG. 4 can be made to change as displays 10C, 10D and arms 12A are reprogrammed to take on varying patterns and colors.

FIG. 5 depicts a child's or infant's plush toy, such as the teddy bear depicted, incorporating a flexible display 10E on the surface. A display may be incorporated on any surface or an entire toy may be made of a flexible display. Switches or sensors may be incorporated within the toy to detect pressure on the toy's surfaces, sound or motion of the toy, so that programming of display 10E, as well as sound, if incorporated, may be made responsive to touch or motion of the toy.

FIG. 6 depicts a child's entertainment device provided by displays 10F and/or 10G attached to a stroller. Display 10F is a wrap-around display for attachment to a stroller bar 14, which includes an attachment feature such as VELCRO strips for securing display 10F to stroller bar 14, snaps or other suitable attachment arrangement. Wrap-around display 10F can also be used in other child/infant devices that have bars, such as hi-chairs, baby carriers and car seats. Display 10G is a flat-panel display attached to the stroller body (or stroller bar 14) via a clamping arrangement or other suitable attachment, whereby display 10G is presented for viewing by a child or infant. FIG. 7 similarly depicts a child or infant's car seat including flat-panel display 10G, wrap-around display 10F (this time attached to a car seat bar 14A) and shape-cut displays 10C as included in the above-described mobiles of FIGS. 3 and 4.

FIG. 8 depicts the use of a flexible display for entertaining a child or infant while in an automobile. Display 10H, provided in a thin, flexible package similar to the playmat/screen of FIG. 1, can be positioned over the back of the front seat of the automobile and either draped for holding by the weight of the device or attached with straps, loop fasteners (such as VELCRO) or other suitable means. Display 10H can also be positioned for infants in rear-facing car seats as shown toward the rear of the figure.

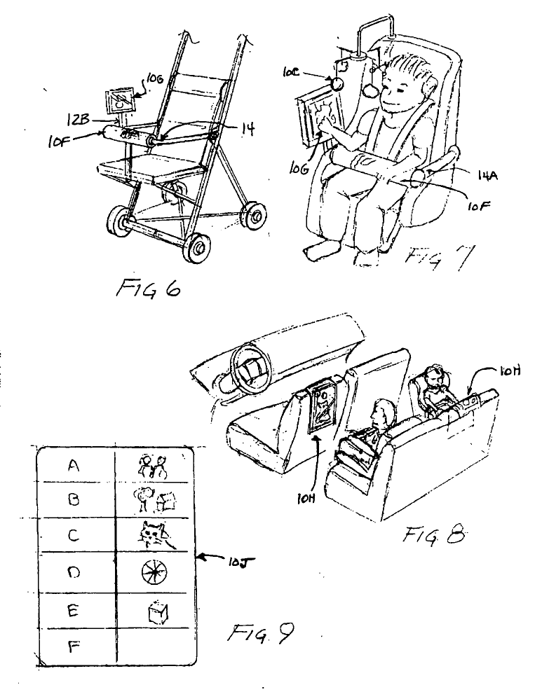

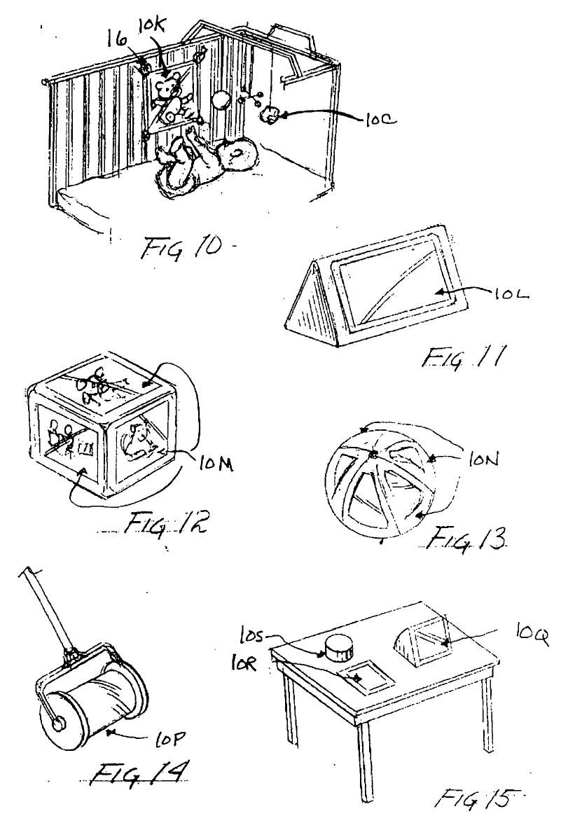

FIG. 9 depicts an exemplary display 10J programming scheme for a child. While programming screens for infants will include images and colors (such as the animals depicted in some of the figures), display 10J is programmed with smaller images including letters, images of shapes, animals, etc. for use in puzzles, tests and games for challenging children, providing an educational as well as an entertainment function. A touchscreen may be incorporated in any of the displays for interaction with the shapes and solving puzzles, taking tests and playing games.

FIG. 10 depicts a flexible display 10K affixed to a crib for holding an infant or small child. Display 10K provides entertainment and stimulus via programming. Straps 16 (such as VELCRO straps) or another attachment device are provided for affixing display 10K to the crib bars. (Alternatively, attachment points may be provided on the crib via snap or other fasteners and display 10K may be attached to other points on the crib). Also shown is the use of mobile 10C as described above in conjunction with display 10K.

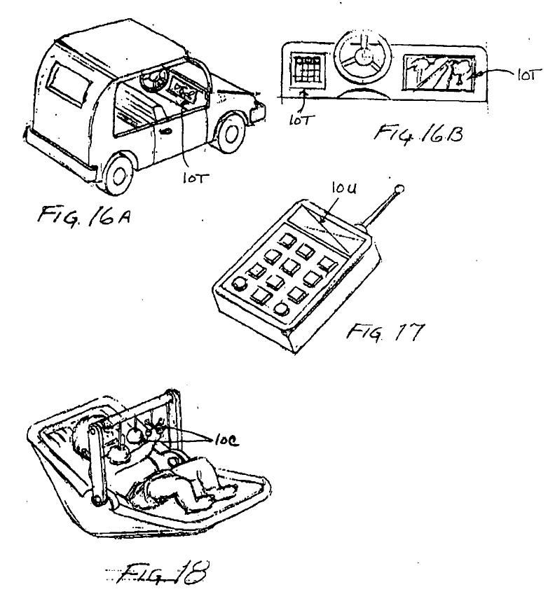

FIG. 11 depicts a shaped object for play by an infant and incorporating a display 10L on a face thereof. FIG. 12 is illustrative of another shaped play object having displays 10M incorporated on multiple faces. FIG. 13 depicts a ball having displays 10N incorporated on sections approximating the spherical surface of the ball. All of the above described play items will generally incorporate flexible displays, but may also be made incorporating more rigid displays and structures where the play items are intended for use by older children, and safety does not dictate the use of flexible displays.

FIGS. 14-17 depict play devices that emulate actual items used by adults or other children. FIG. 14 depicts a well-known toy shape referred to as a “popper” that emulates a cleaning device in child play. A display 10P is incorporated that can be programmed to display colors and shapes, or even balls moving within a clear plastic tube (as the original toy employed) providing a visually stimulating display. FIG. 15 depicts a play desk including display device 10R incorporated conformal to the top surface, display 10Q angled above the top surface and display 10S incorporated on an object on the surface. FIG. 16A depicts a toy car of a type that may be entered or propelled by a child and alternatively a child's play car of a smaller size. Displays 10T provide a road-view and dashboard control view, which may be separate displays, to enhance the car-play experience. FIG. 17 is exemplary of a toy mobile telephone that incorporates a display 10U that may be programmed to provide non-standard display (such as flashing colors) for an infant, or more typical mobile phone type of display for an older child. Each of the above-described play devices of FIGS. 14-17 can be made of a-flexible soft material (such as open-cell foam) and include flexible displays making them suitable for use by infants.

FIG. 18 is an illustration of a baby carrier in accordance incorporating shape-cut displays 10C as described for the mobiles of FIGS. 3 and 4, as well as the car carrier of FIG. 7 and the crib of FIG. 10.

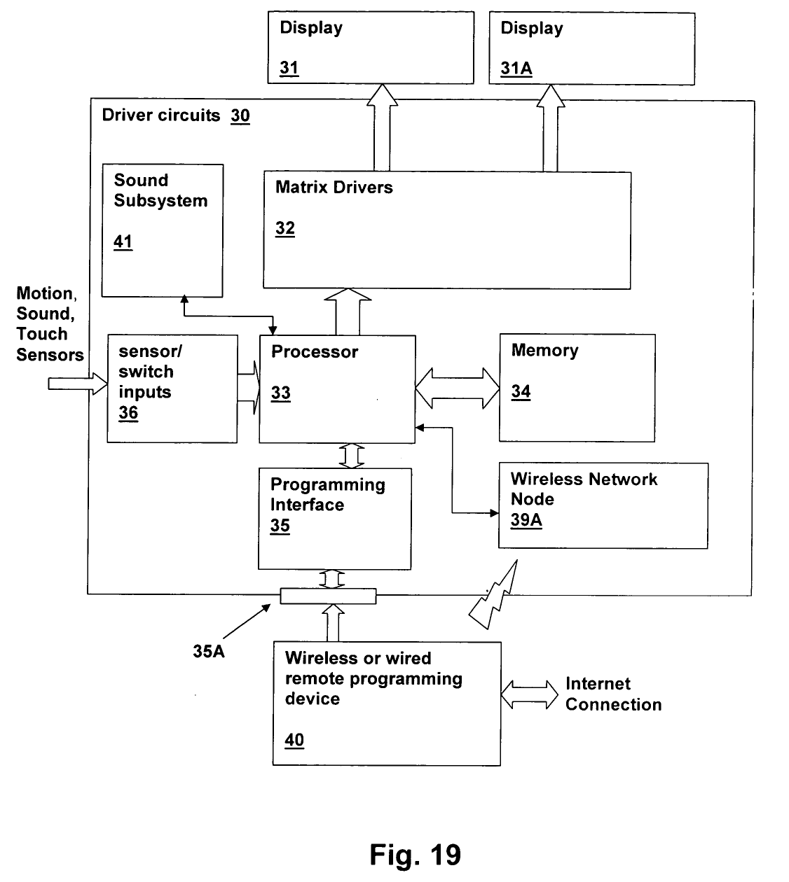

Referring now to FIG. 19, driver circuits 30 suitable for use within the above-described devices are shown in a block diagram. Displays 31 and 31A (to illustrate multiple displays not limited to two) which are affixed to the body of a child's or infant's play or entertainment device, are coupled to a set of matrix drivers 32. Displays 31 and 31A may each comprise a further plurality of electronic displays all connected to matrix driver 32 and may be individually selectable via matrix drivers 32. Matrix drivers 32 are coupled to processor 33 for receiving information corresponding to text, graphics and colors displayed on display 31 and processor 33 is coupled to a memory 34 for storing program instructions for execution by processor 33 and data corresponding to graphical images, text and colors for display on display 31. A sound subsystem 41 is coupled to processor 33 for providing audio to further enhance the play or entertainment experience.

A wireless network node 39A, which may be an Internet node, is coupled to processor 33 to provide receipt of wireless communications and information from a wireless remote programming device 40, such as images, sound and graphics as well as parent (or other child) interactivity via controls or remote programming device 40 or via a computer connected via the Internet or direct connection to remote programming device 40. Remote programming device can be connected via a wireless interface as described above, or detachably coupled through a connector 35A directly to a hardwired programming interface 35. Alternatively, cartridges may be provided an inserted in connector 35A for loading data from the cartridges into the device.

Sensor/switch input interface 36 is coupled to processor 33 and may be coupled to sensors (such as motion sensors, touch sensors and sound sensors), switches or buttons mounted on the play device or display. Sensor/switch input interface 36 also couples any provided touch-screens integrated with displays 31 and 31A. Power for displays 31 and driver circuit 30 may be provided by a battery, and solar cells or kinetic electrical devices may be used to either re-charge the battery, or may be used in some embodiments for providing all of the power source. Alternatively, for some play devices a wall AC or DC power supply may be used or a full line power supply incorporated within the device body, as long as safety requirements are met.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A device for providing a visual display to a child/infant for play or entertainment, comprising:
a flexible device body of a form for providing a child/infant play or entertainment;
one or more flexible multipixel displays mounted on at least one surface of said device body for providing a visual display to said child/infant;
a driver circuit coupled to said display array for providing electronic signals controlling said visual display; and
a processor coupled to said driver circuit for programming said electronic signals.

2. The device of claim 1, wherein said one or more displays is an light-emitting diode (LED) display.

3. The device of claim 2, wherein said one or more displays is an organic light-emitting diode (OLED) display.

4. The device of claim 1, wherein said device is a child/infant transportation device.

5. The device of claim 4, wherein said transportation device includes a bar for retaining a child or infant, wherein said multipixel display is a flexible display, and wherein said flexible display is adapted for attachment around a circumference of said bar.

6. The device of claim 4, wherein the device includes a mobile attached to the transportation device including a plurality of suspended mobile figures, and wherein at least one of said one or more displays forms a surface of at least one of said mobile figures.

7. The device of claim 1, wherein the device is a child/infant plush toy and said multipixel display forms a portion of said surface of said plush toy.

8. The device of claim 1, wherein said device is a child/infant toy emulating an adult device having a display, wherein said device body is a flexible device body, and wherein said display emulates a display on the corresponding adult device.

9. The device of claim 1, wherein said device is a device for suspension over a child in a crib.

10. The device of claim 9, wherein said device is a mobile including a plurality of mobile figures and suspension arms for suspending said mobile figures, and wherein at least one of said one or more displays forms a surface of at least one of said mobile figures.

11. The device of claim 10, wherein said at least one display is shape-cut for providing an outline of said at least one mobile figure.

12. The device of claim 9, wherein at least one of said suspension arms includes at least one of said one or more displays conformal to a surface of the at least one suspension arm, whereby said suspension arm display is programmed to further provide a visual display.

13. The device of claim 1, wherein the display is a flat flexible display adapted for use on a automobile seat, whereby the device is draped over the automobile seat and said display is thereby presented for viewing by a child.

14. The device of claim 1, wherein the display is a flat flexible display adapted for attachment to a crib or playpen, whereby the display is held vertically for viewing by a child in said crib or playpen.

15. The device of claim 1, wherein the device is a play desk having a flexible body and wherein said at least one display is arranged on a top surface of the play desk, whereby a child/infant sitting at said play desk can view said one or more displays.

16. The device of claim 1, wherein the device is a toy in the form of a simple geometric solid, and wherein said at least one display occupies at least one face of the toy.

17. The device of claim 16, wherein said toy is in the form of a ball having surface sections approximating a sphere, wherein at least one of said sections is occupied by one of said at least one displays.

18. The device of claim 1, wherein said toy is in the form of a push toy having a handle and a rollable element disposed at one end, and wherein said at least one display is disposed on a surface of said rollable element.

19. A device for providing a visual display to a child/infant for play or entertainment, comprising:
a device body of a form for providing a child/infant play or entertainment;
one or more multipixel displays mounted on at least one surface of said device body for providing a visual display to said child/infant;
a driver circuit coupled to said display array for providing electronic signals controlling said visual display; and
a processor coupled to said driver circuit for programming said electronic signals.

20. The device of claim 19, wherein said one or more displays is a light-emitting diode (OLED) display.

21. The device of claim 20, wherein said one or more displays is an organic light-emitting diode (OLED) display.

22. The device of claim 20, wherein said device is a child/infant transportation device.

23. The device of claim 20, wherein said multipixel display is contained in a housing and wherein said housing is adapted for attachment to a frame of said infant/child transportation device.

24. The device of claim 20, wherein said device is a child/infant toy emulating an adult device having a display, and wherein said display emulates the display on a corresponding adult device.
